(19) United States
(12) Patent Application Publication
(10) Pub. No.: US 2014/0056213 A1
(43) Pub. Date: Feb. 27, 2014

(54) RADIO RELAY METHOD, BASE STATION, AND RADIO COMMUNICATION SYSTEM

(71) Applicants: Jungo Goto, Osaka-shi (JP); Hiroki Takahashi, Osaka-shi (JP); Osamu Nakamura, Osaka-shi (JP); Kazunari Yokomakura, Osaka-shi (JP); Yasuhiro Hamaguchi, Osaka-shi (JP)

(72) Inventors: Jungo Goto, Osaka-shi (JP); Hiroki Takahashi, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/116,461

(22) PCT Filed: Apr. 26, 2012
(86) PCT No.: PCT/JP2012/061223

§ 371 Date: Nov. 8, 2013

(30) Foreign Application Priority Data
May 11, 2011 (JP) 2011-106067

(51) Int. Cl. H04W 72/04

(52) U.S. Cl. CPC H04W 72/04
USPC 370/315

(57) ABSTRACT

A frequency resource required for communication between an RS and an eNB is reduced. Provided is a radio relay method for relaying a radio signal exchanged between a mobile station and a base station. The radio relay method includes performing relaying such that a frequency to be used in a case of relaying at least one of transmission signals transmitted from a plurality of mobile stations is overlapped with and allocated to at least a part of a frequency to which another non-relayed transmission signal is allocated. The frequency to be used for transmitting the relayed transmission signal may be disposed discretely on a frequency axis.

### TECHNICAL FIELD

The present invention relates to a transmission method of a radio communication system having a relay station.

### BACKGROUND ART

As a radio communication system of fourth-generation mobile phones, LTE-A (also called LTE-Advanced, IMT-A, etc.), which is an advanced version of an LTE (Long Term Evolution) system, is being standardized.

In an LTE-A system, incorporation of a relay station that relays communication between a mobile station and a base station is being studied for improving coverage (see Non Patent Literature 1). A relay station uses a relay method such as an AF (amplify-and-forward) method and a DF (decode-and-forward) method. An AF-type relay station transmits a received signal after performing only amplification processing thereon, whereas a DF-type relay station performs decoding processing on a received signal, modulates the signal again if there is no error, and transmits the signal. In particular, with the DF type, since the signal is demodulated once, it is possible to change the transmission method to the method used between a mobile station and the relay station on the basis of the communication quality between the relay station and the base station.

FIG. 16 schematically illustrates an uplink relay system. In the drawing, there are mobile stations (each referred to as “UE” hereinafter) 3-1 to 3-4 (UEs 3-1 to 3-4 will collectively be expressed as “UEs 3”) that are capable of simultaneously accessing a base station (referred to as “eNB” hereinafter) 1 within a cell, and there is a relay station (referred to as “RS” hereinafter) 5 that relays a transmission signal of the UE 3-1 located at a cell edge. In a case where the RS 5 performs relaying based on the DF method, since the RS 5 decodes the signal of the UE 3-1 and then generates a signal to be transmitted to the eNB 1, overhead (processing delay) is required for the relaying. Consequently, since the transmission timing of the UE 3-1 is different from the transmission timing of the RS 5, in order to prevent interference therebetween, the signal is transmitted at a transmission timing of a subsequent frame (sub-frame) by using an uplink frequency resource designated by the eNB 1.

### CITATION LIST

### Non Patent Literature

NPL 1: 3GPP TS 36.216 (V10.1.0) “Evolved Universal Terrestrial Radio Access (E-UTRA) Physical layer for relaying operation”

### SUMMARY OF INVENTION

### Technical Problem

However, in the relaying operation performed at different transmission timings as in the DF-type RS 5, since the RS 5 uses a frequency resource corresponding to another time for transmission, new frequency allocation (frequency resource) is necessary. This is a problem in that a larger number of resources (time-frequency resources) is required, as compared with a case where relaying is not performed.

The present invention has been made in view of these circumstances, and an object thereof is to provide a radio relay method, a base station, and a radio communication system that reduce frequency resources required for the communication between the RS 5 and the eNB 1.

### Solution to Problem

(1) In order to achieve the aforementioned object, the present invention provides the following solutions. Specifically, a radio relay method according to the present invention is for relaying a radio signal exchanged between a mobile station and a base station. The radio relay method includes performing relaying such that a frequency to be used in a case of relaying at least one of transmission signals transmitted from a plurality of mobile stations is overlapped with and allocated to at least a part of a frequency to which another non-relayed transmission signal is allocated.

Accordingly, a relay station performs relaying such that the frequency to be used in a case of relaying at least one of the transmission signals transmitted from the plurality of mobile stations is overlapped with and allocated to at least a part of the frequency to which the other non-relayed transmission signal is allocated. Thus, frequency allocation for maintaining the orthogonality of frequencies used for transmission by each UE and the RS becomes unnecessary. This allows for efficient frequency use by a radio communication system including the RS, thereby allowing for improved frequency utilization efficiency.

(2) Furthermore, in the radio relay method according to the present invention, the frequency to be used for transmitting the relayed transmission signal is disposed discretely on a frequency axis.

Accordingly, since the frequency to be used for transmitting the relayed transmission signal is disposed discretely on the frequency axis, the relay station can reduce the percentage of overlapping spectrum of each UE.

(3) Furthermore, in the radio relay method according to the present invention, reception power of the relayed transmission signal at the base station is higher than reception power of the other non-relayed transmission signal at the base station.

Accordingly, the relay station sets the reception power of the relayed transmission signal at the base station to be higher than the reception power of the other non-relayed transmission signal at the base station. This facilitates signal separation in reception processing so that an effect of overlapping the spectra relative to the transmission characteristics is reduced, thus allowing for improved throughput.

(4) Furthermore, in the radio relay method according to the present invention, at least one of a modulation level and a coding rate of the relayed transmission signal is lower than a modulation level or a coding rate of the other non-relayed transmission signal.

Accordingly, the relay station sets at least one of a modulation level and a coding rate of the relayed transmission signal to be lower than a modulation level or a coding rate of the other non-relayed transmission signal. Thus, the base station can readily separate signals allocated by overlapping the spectra of the RS and each UE, so that an effect of overlapping the spectra relative to the transmission characteristics is reduced, thus allowing for improved throughput.

(5) Furthermore, in the radio relay method according to the present invention, error correction coding relative to the relayed transmission signal is different from error correction coding relative to the other non-relayed transmission signal.

Accordingly, since the error correction coding relative to the relayed transmission signal is different from the error correction coding relative to the other non-relayed transmission signal, the base station can readily separate signals allocated by overlapping the spectra of the RS and each UE, so that an effect of overlapping the spectra relative to the transmission characteristics is reduced, thus allowing for improved throughput.

(6) Furthermore, in the radio relay method according to the present invention, the frequency to be used for transmitting the relayed transmission signal is the same as the frequency to which the other transmission signal transmitted from the corresponding mobile station is allocated.

Accordingly, since the frequency to be used for transmitting the relayed transmission signal is the same as the frequency to which the other transmission signal transmitted from the corresponding mobile station is allocated, the frequency position and the bandwidth to be used for transmission by the RS do not need to be changed, whereby simple relaying processing can be realized.

(7) A base station according to the present invention receives a radio signal from a mobile station and a relay station. In the base station, replicas are generated based on a transmission signal relayed at the relay station and a transmission signal transmitted from each mobile station. Specifically, the relayed transmission signal is relayed at the relay station such that a frequency to be used in a case of relaying at least one of transmission signals transmitted from a plurality of mobile stations is overlapped with and allocated to a part of a frequency to which another non-relayed transmission signal is allocated. The generated replicas are used for interference removal so as to perform reception processing on the transmission signal transmitted from the relay station and the transmission signal transmitted from each mobile station.

Accordingly, replicas are generated based on the relayed transmission signal and the transmission signal transmitted from each mobile station. Specifically, the relayed transmission signal is relayed such that the frequency to be used in a case of relaying at least one of the transmission signals transmitted from the plurality of mobile stations is overlapped with and allocated to a part of the frequency to which the other non-relayed transmission signal is allocated. The generated replicas are used for interference removal so as to perform reception processing on the transmission signal transmitted from the relay station and the transmission signal transmitted from each mobile station. Thus, the base station does not need to perform frequency allocation for maintaining the orthogonality of frequencies used for transmission by each UE and the RS. This allows for efficient frequency use by a radio communication system including the RS, thereby allowing for improved frequency utilization efficiency.

(8) Furthermore, in the base station according to the present invention, the relay station is notified that at least one of a modulation level and a coding rate of the relayed transmission signal is lower than a modulation level or a coding rate of the other non-relayed transmission signal.

Accordingly, the base station notifies the relay station that at least one of the modulation level and the coding rate of the relayed transmission signal is lower than the modulation level or the coding rate of the other non- relayed transmission signal. This facilitates separation of signals allocated by overlapping the spectra of the RS and each UE, so that an effect of overlapping the spectra relative to the transmission characteristics is reduced, thus allowing for improved throughput.

(9) Furthermore, in the base station according to the present invention, reception processing for combining the transmission signal transmitted from each mobile station with the transmission signal relayed by the relay station is performed.

Accordingly, the base station performs reception processing for combining the transmission signal transmitted from each mobile station with the transmission signal relayed by the relay station. This facilitates separation of signals allocated by overlapping the spectra of the RS and each UE, so that an effect of overlapping the spectra relative to the transmission characteristics is reduced, thus allowing for improved throughput.

(10) A radio communication system according to the present invention includes a mobile station, a base station, and a relay station. The relay station relays a radio signal exchanged between the mobile station and the base station. In the radio communication system, the relay station performs relaying such that a frequency to be used in a case of relaying at least one of transmission signals transmitted from a plurality of mobile stations is overlapped with and allocated to at least a part of a frequency to which another non-relayed transmission signal is allocated.

Accordingly, because relaying is performed such that the frequency to be used in a case of relaying at least one of the transmission signals transmitted from the plurality of mobile stations is overlapped with and allocated to at least a part of the frequency to which the other non-relayed transmission signal is allocated, the base station does not need to maintain the orthogonality of frequencies used for transmission by each UE and the RS. This allows for efficient frequency use by the radio communication system including the RS, thereby allowing for improved frequency utilization efficiency.

### Advantageous Effects of Invention

With application of the present invention, the frequency resource used in the communication between the RS 5 and the eNB 1 does not tighten the resource of communication between each UE 3 and the eNB 1 not intervened by the RS 5, thereby achieving improved frequency utilization efficiency and improved throughput.

### BRIEF DESCRIPTION OF DRAWINGS

FIG. 1 is a block diagram illustrating an example of UEs 3 according to the present invention.

FIG. 2A illustrates allocation of a single-carrier spectrum.

FIG. 2B illustrates discrete frequency allocation.

FIG. 3 is a block diagram illustrating a configuration example of an RS 5 having a single transmission-reception antenna, in accordance with the present invention.

FIG. 4 is a block diagram illustrating a configuration example of a receiving section 203 according to the present invention.

FIG. 5 is a block diagram illustrating a configuration example of a transmitting section 205 according to the present invention.

FIG. 6 is a block diagram illustrating a configuration example of an eNB 1 that simultaneously receives data transmitted from multiple UEs 3 via and without via the RS 5, in accordance with a first embodiment of the present invention.

FIG. 7A illustrates reception spectra at the eNB 1, showing a frequency allocation method in a radio communication system in the related art that uses the RS 5.

FIG. 7B illustrates reception spectra at the eNB 1, showing a frequency allocation method in the radio communication system in the related art that uses the RS 5.

FIG. 8 illustrates an example of frequency allocation of the RS 5 according to the first embodiment of the present invention.

FIG. 9 illustrates an example of discrete frequency allocation of the RS 5 according to the first embodiment of the present invention.

FIG. 10 is a block diagram illustrating a configuration example of a part of the eNB 1 in a case where a signal transmitted from each UE 3 and a relayed signal are to be combined, in accordance with the first embodiment of the present invention.

FIG. 11 is a sequence chart illustrating the operation of a communication system according to the present invention.

FIG. 12 illustrates an example of frequency allocation of each UE 3 and an RS 5 according to a second embodiment of the present invention.

FIG. 13 is a block diagram illustrating a configuration example of a part of an eNB 1 according to the second embodiment of the present invention.

FIG. 14 illustrates an example of frequency allocation of each UE 3 and an RS 5 according to a third embodiment of the present invention.

FIG. 15 illustrates another example of frequency allocation of each UE 3 and the RS 5 according to the third embodiment of the present invention.

FIG. 16 schematically illustrates an uplink relay system.

### DESCRIPTION OF EMBODIMENTS

Embodiments of the present invention will be described below with reference to the drawings. The description of each of the following embodiments relates to transmission (uplink) in which a transmitting device that transmits data is defined as UE 3 and a receiving device that receives data is defined as eNB 1.

### First Embodiment

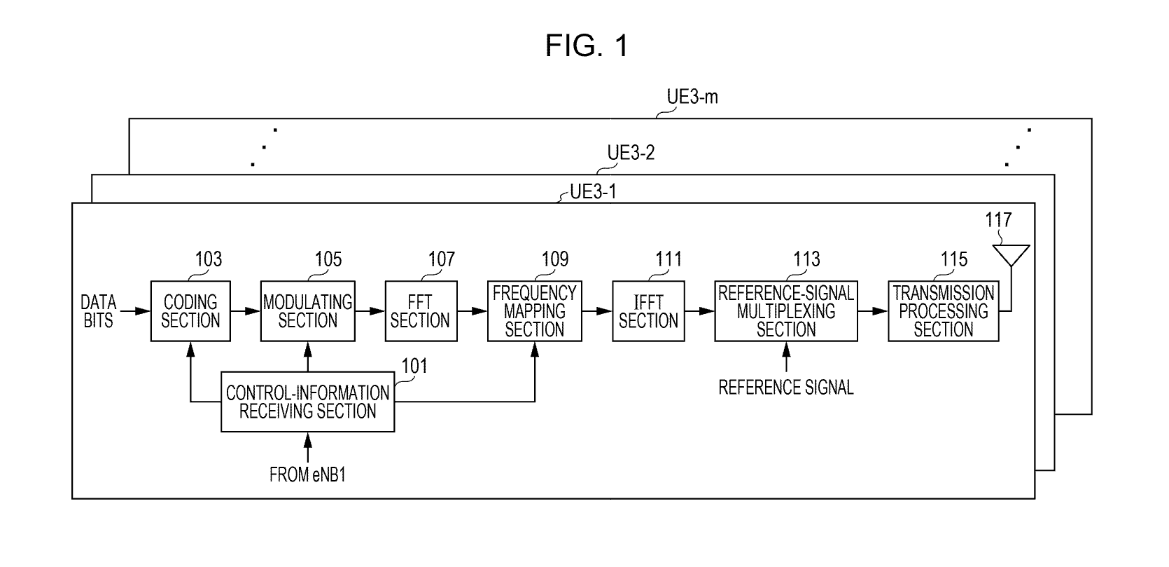

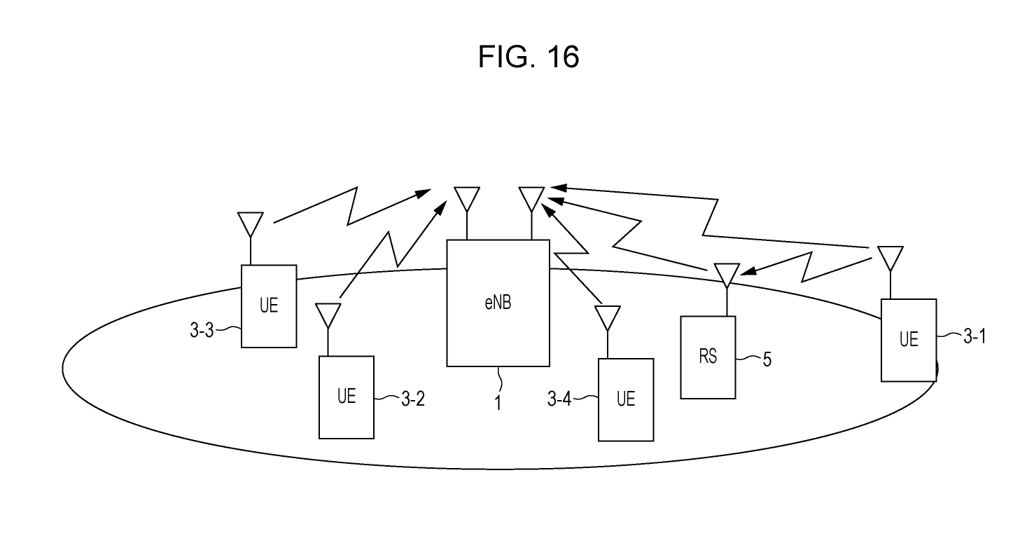

FIG. 1 is a block diagram illustrating an example of the UEs 3 according to the present invention. It should be noted that a minimal block diagram required for explaining the present invention is shown. With regard to the UEs 3 in FIG. 1, the number of UEs 3 is m, and the UE 3-1 to UE 3-m transmit data to the eNB 1 in a manner similar to the UE 3-1 to UE 3-4 in FIG. 16. Although each UE 3 in the drawing has a single antenna, the UE 3 may use multiple antennas for transmission and reception for transmission diversity or MIMO (multiple input multiple output) transmission. Because the UEs 3 perform the same data transmission processing, only the UE 3-1 will be described in this embodiment. In the UE 3-1, a control-information receiving section 101 receives control information notified from the eNB 1. The control information includes information to be used for data transmission, such as frequency allocation information, a modulation level, a coding rate, and a coding method. The control-information receiving section 101 inputs the coding-rate information and the coding-method information included in the received control information to a coding section 103, the modulation-level information to a modulating section 105, and the frequency allocation information to a frequency mapping section 109.

The coding section 103 performs error correction coding, such as turbo coding and LDPC (low density parity check) coding, on the input data bits. The error correction coding performed in the coding section 103 may be set in advance at the time of transmission and reception or may be notified as the control information. The coding section 103 also performs puncture on the basis of the coding-rate information notified as the control information and outputs the coded bits to the modulating section 105. Based on a modulation method, such as QPSK (quarternary phase shift keying), 16-QAM (16-ary quadrature amplitude modulation), or 64-QAM, the modulating section 105 performs modulation on the coded bits in accordance with the modulation level input from the control-information receiving section 101. A modulation symbol output from the modulating section 105 is converted into a frequency-domain data signal from a time-domain data signal by an FFT section 107. Then, the signal is output to the frequency mapping section 109.

The frequency mapping section 109 performs signal allocation on the input frequency-domain data signal on the basis of the frequency allocation information notified from the control-information receiving section 101.

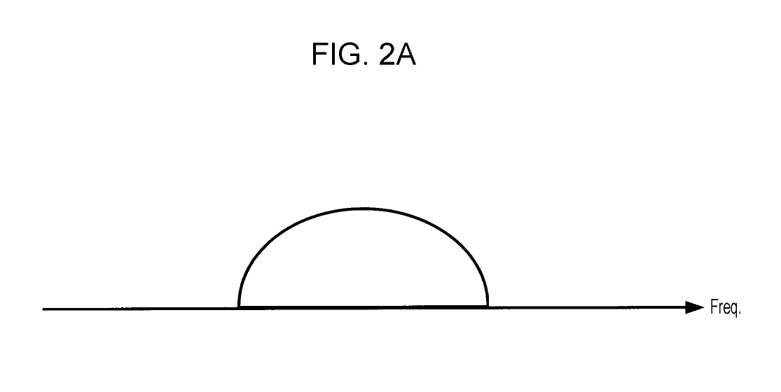

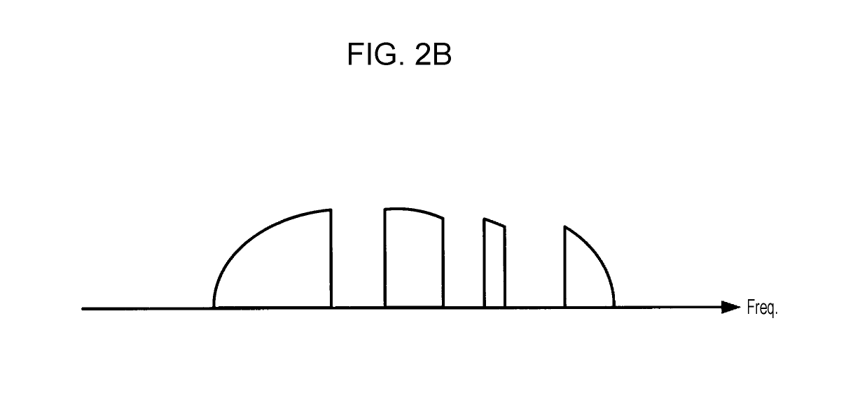

FIG. 2A illustrates allocation of a single carrier spectrum. In DFT-S-OFDM (discrete Fourier transform spread orthogonal frequency division multiplexing, also called SC-FDMA), which is continuous frequency allocation, a single carrier spectrum is allocated as in FIG. 2A.

FIG. 2B illustrates discrete frequency allocation. In clustered DFT-S-OFDM, which is discrete frequency allocation, the allocation is as shown in FIG. 2B. The signal output from the frequency mapping section 109 is converted into a time-domain signal by an IFFT section 111. A reference-signal multiplexing section 113 performs processing for multiplexing a reference signal, which is known in the transmitting-receiving device, onto the transmission signal in a time domain. Although the reference signal is multiplexed in a time domain in this example, the reference signal may alternatively be multiplexed in a frequency domain.

A transmission processing section 115 inserts a CP (cyclic prefix) to the signal having the reference signal multiplexed thereon. The signal is then converted into an analog signal by D/A (digital/analog) conversion and is subsequently up-converted to a radio frequency. After the up-conversion, the signal is amplified to transmission power by a PA (power amplifier) and is subsequently transmitted from a transmission antenna 117. The UE 3-2 to UE 3-m perform data transmission in a similar manner.

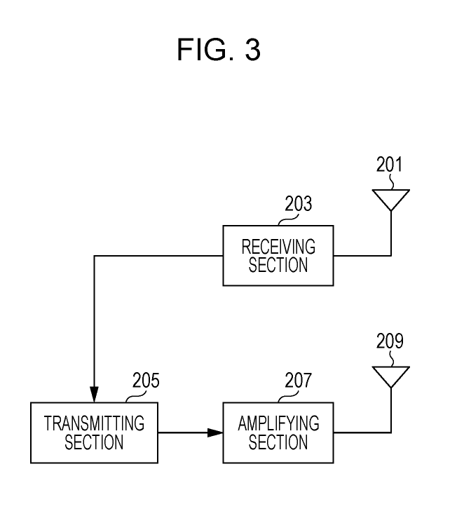

FIG. 3 is a block diagram illustrating a configuration example of an RS 5 having a single transmission-reception antenna in the present invention. Alternatively, multiple transmission-reception antennas may be provided. The RS 5 receives a signal from a UE 3 via an antenna 201 and obtains data bits transmitted via a receiving section 203.

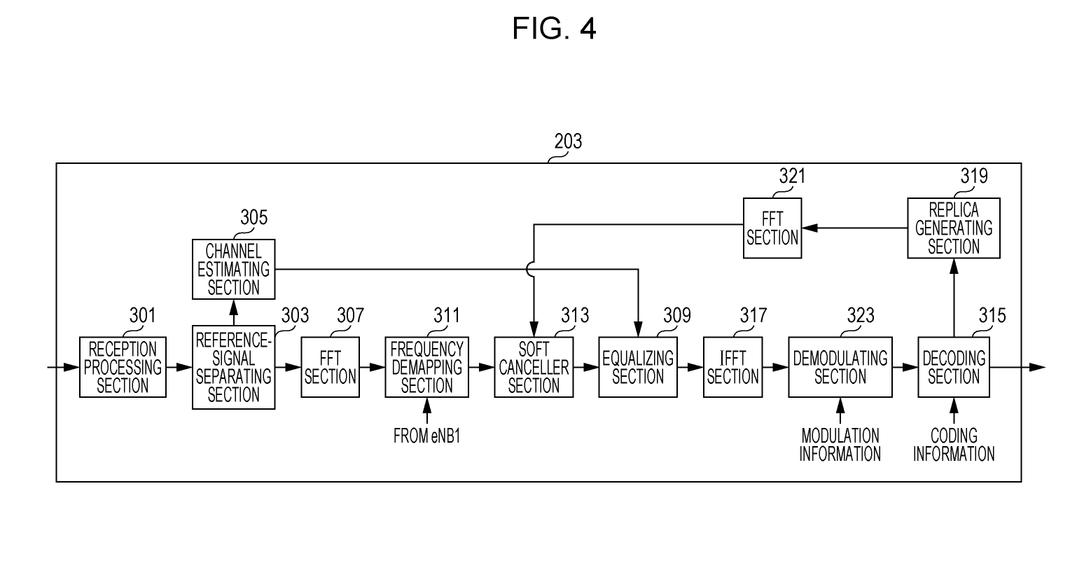

FIG. 4 is a block diagram illustrating a configuration example of the receiving section 203 in the RS 5 according to the present invention. A process for obtaining data bits will be described below with reference to this drawing. A signal received via the antenna 201 is down-converted into a baseband frequency at a reception processing section 301 and undergoes A/D conversion so as to be converted into a digital signal. Then, a cyclic prefix is removed from the digital signal. The signal output from the reception processing section 301 is separated into a reference signal and a data signal by a reference-signal separating section 303. The reference signal is output to a channel estimating section 305 and the data signal is output to an FFT section 307. The channel estimating section 305 estimates a frequency response of a channel in accordance with the reference signal known in the transmitting-receiving device and outputs the estimated channel characteristics to an equalizing section 309.

On the other hand, the data signal separated by the reference-signal separating section 303 is converted into a frequency-domain signal from a time-domain signal at the FFT section 307 and is subsequently output to a frequency demapping section 311. Based on the frequency allocation information notified as the control information to the UE 3 from the eNB 1, the frequency demapping section 311 extracts a continuously or discretely allocated frequency-domain signal. The extracted signal is input to a soft canceller section 313 where a frequency-domain replica generated from decoded bits obtained by a decoding section 315 is cancelled. However, in the first soft cancellation processing, nothing is performed since there is no information obtained by the decoding section 315. The equalizing section 309 performs equalization processing for correcting distortion in a radio channel in accordance with the channel characteristics input from the channel estimating section 305 and outputs the signal to an IFFT section 317. In this case, the equalization processing includes, for example, multiplying MMSE (minimum mean square error) weight or ZF (zero forcing) weight.

The signal input from the equalizing section 309 is converted into a time-domain signal from a frequency-domain signal by the IFFT section 317. The modulation-level information notified as the control information to the UE 3 is also notified to the RS 5. Based on the modulation-level information, symbol demodulation is performed. The demodulated bits undergo error correction decoding by the decoding section 315 on the basis of the coding-rate information notified as the control information to the UE 3, whereby data bits are obtained. The decoding result is output to a replica generating section 319 if turbo equalization processing is to be performed. The replica generating section 319 modulates the decoded bits again so as to generate a replica. An FFT section 321 converts the generated time-domain replica into a frequency-domain replica and inputs the replica to the soft canceller section 313. By repeating the above processing, reception processing is performed on the data transmitted by the UE 3. This processing is repeated until there is no detection of an error in CRC (cyclic redundancy check) or until the number of times the processing is repeated reaches a predetermined upper-limit value.

If the decoding result is not correct based on CRC, nothing is performed in the decoding section 315 since relaying is not to be performed. If correct data bits are obtained based on CRC, the data bits are input to a transmitting section 205.

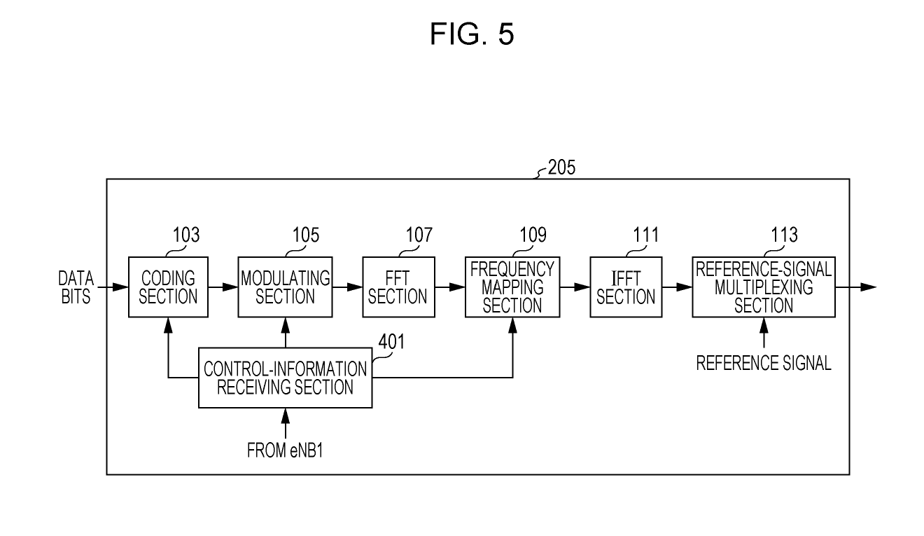

FIG. 5 is a block diagram illustrating a configuration example of the transmitting section 205 of the RS 5 according to the present invention. Since the processing from the coding section 103 to the reference-signal multiplexing section 113 is the same as that in the UE 3, a description thereof will be omitted. Furthermore, it is assumed that a control-information receiving section 401 receives the control information used in the communication between the RS 5 and the eNB 1. Therefore, the coding method, the coding rate, the modulation level, and the frequency allocation may be different between the signal transmitted from the RS 5 and the signal transmitted from the UE 3.

Although not shown, the transmitting section 205 performs CP insertion, D/A conversion, that is, conversion into an analog signal, and radio frequency up-conversion on the time-domain signal having the reference signal multiplexed thereon, and inputs the signal to an amplifying section 207. The amplifying section 207 amplifies the input signal to transmission power used for the communication between the RS 5 and the eNB 1. In this case, the transmission power of the RS 5 may be set in advance or may be designated from the eNB 1 based on the control information. Furthermore, since the RS 5 has extra transmission power relative to that of the UE 3, the transmission power of the RS 5 may be set such that the reception power at the eNB 1 is higher than that at the UE 3. The amplified signal is transmitted from a transmission antenna 209.

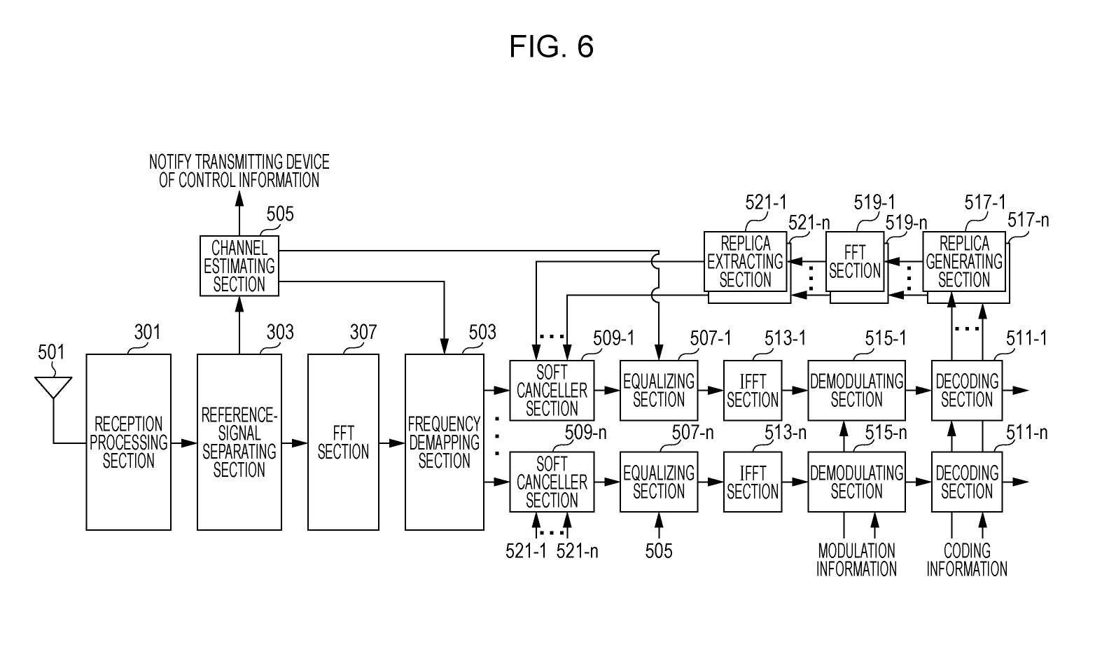

FIG. 6 is a block diagram illustrating a configuration example of the eNB 1 that simultaneously receives data transmitted from multiple UEs 3 via and without via the RS 5, in accordance with the first embodiment of the present invention. In the drawing, the total number of RSs 5 and UEs 3 from which data is simultaneously received is defined as n. Although a single transmission-reception antenna is provided, multiple antennas may alternatively be provided. At the eNB 1, a signal from a UE 3 or the RS 5 is received via an antenna 501. The processing from the reception processing section 301 to the FFT section 307 is the same as that in FIG. 4, and the frequency-domain signal output from the FFT section 307 is input to a frequency demapping section 503.

A channel estimating section 505 estimates a frequency response of a channel between the RS 5 from which data is received and the eNB 1 as well as a frequency response of a channel between the UE 3 from which data is received and the eNB 1 in accordance with the reference signals known in the transmitting-receiving devices and outputs the estimated channel characteristics to equalizing sections 507-1 to 507-n. Furthermore, the frequency allocation, the coding rate, the modulation method, and the like used for data transmission by the UE 3 or the RS 5 are determined in accordance with the estimated channel characteristics and are transmitted as control information. Since these pieces of control information are also necessary for data reception processing, they are stored based on the notified control information until the transmitted data is received.

On the other hand, the frequency demapping section 503 receives frequency allocation information of all the transmitting devices (UE 3 or RS 5) stored in the channel estimating section 505 and performs signal separation for each transmitting device on the basis of the allocation information. Since the separated signals of the respective transmitting devices undergo reception processing on a transmitting-device by transmitting-device basis, the signals are input to respective soft canceller sections 509-1 to 509-n. With regard to the processing from the soft canceller sections 509-1 to 509-n to decoding sections 511-1 to 511-n, since the same processing is performed on each signal transmitted from the corresponding transmitting device, the soft canceller section 509-1 performing the reception processing for the first transmitting device will be described below. The soft canceller section 509-1 receives a frequency-domain replica obtained from the decoding results of all of the transmitting devices and subtracts this replica from the received signal. The soft canceller section will be described in detail later. In the first soft cancellation processing, nothing is performed since there is no information obtained from the decoding sections 511-1 to 511-n. A signal having undergone soft cancellation is converted into a time-domain signal at the equalizing section 507-1 and an IFFT section 513-1 by undergoing processing similar to that in the equalizing section 309 and the IFFT section 317 in FIG. 4. A demodulating section 515-1 receives a modulation level determined at the channel estimating section 505 and notified to the transmitting device, and performs symbol demodulation on the basis of the received modulation-level information. The demodulated bits undergo error correction decoding by the decoding section 511-1 on the basis of information about the coding rate and the coding method determined at the channel estimating section 505 and notified to the transmitting device, whereby data bits are obtained.

If soft cancellation processing is to be performed by using a decoder output based on turbo equalization, the decoding results of the decoding sections 511-1 to 511-n are output to replica generating sections 517-1 to 517-n, respectively. The replica generating section 517-1 and an FFT section 519-1 perform processing on the decoded bits in a manner similar to that in the replica generating section 319 and the FFT section 321 in FIG. 4 so as to generate a frequency-domain replica. A replica extracting section 521-1 will be described in detail later. Only a replica necessary for soft cancellation is extracted for each of the soft canceller sections 509-1 to 509-n, and is input to each of the soft canceller sections 509-1 to 509-n. By repeating the above processing, reception processing is performed on the data transmitted by each transmitting device.

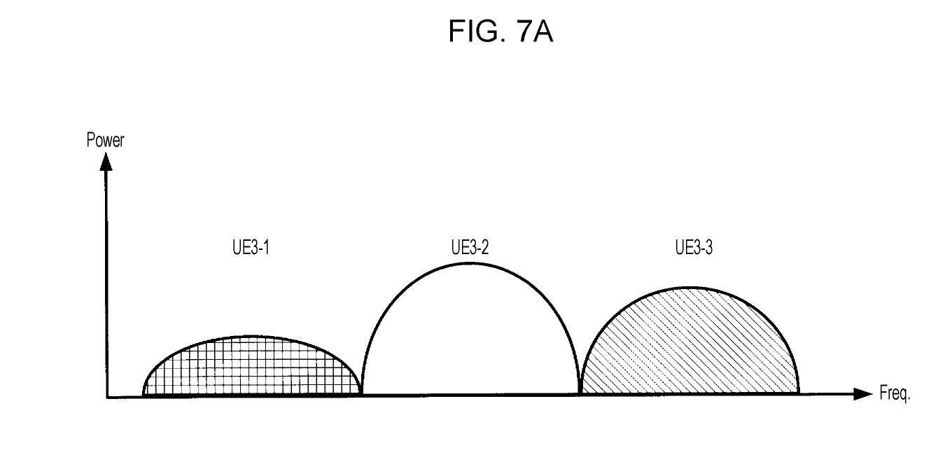

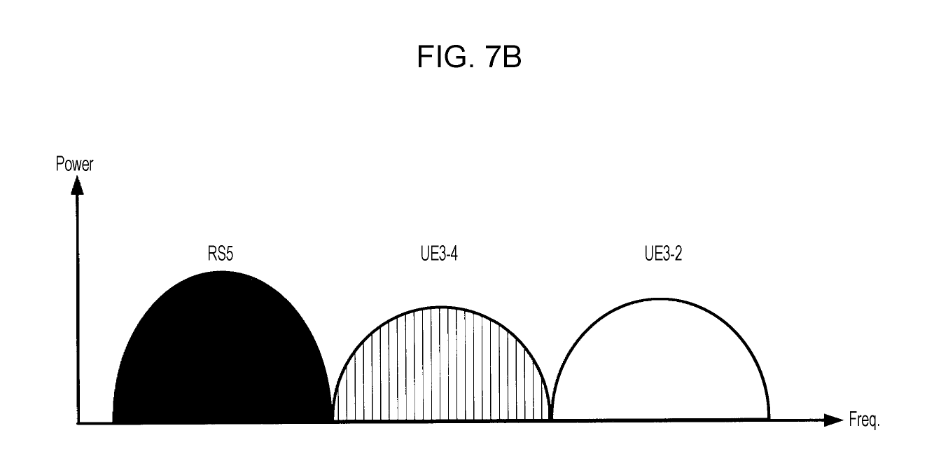

FIGS. 7A and 7B illustrate reception spectra at the eNB 1, showing a frequency allocation method in a radio communication system in the related art that uses the RS 5. A description will be provided below with reference to these drawings. FIG. 7A corresponds to a case where there is no data to be relayed by the RS 5, and communication is performed with the UE 3-1, the UE 3-2, and the UE 3-3 based on frequency division multiple access. FIG. 7B illustrates frequency allocation in a case where data is relayed by the RS 5 because of the power of a reception signal from a UE 3 being low due to being located at a cell edge. In a case where the eNB 1 cannot obtain sufficient reception power for a transmission signal of the UE 3-1, the RS 5 performs reception processing on the transmission signal of the UE 3-1 transmitted at a transmission timing in FIG. 7A, and subsequently transmits the signal to the eNB 1. Although the frequency allocation of the UE 3-1 and the frequency allocation of the RS 5 match in FIGS. 7A and 7B, the allocation and the bandwidth may be changed. As shown in FIG. 7B, the RS 5 of a DF type in this embodiment relays data at a timing different from that of the UE 3-1 and performs frequency division multiple access. Thus, only the RS 5 requires usable frequency allocation. As a result, in order for the eNB 1 to obtain correct data of the UE 3-1 in the example in these drawings, frequency allocation that is twice as that in a case where relaying is not performed is required.

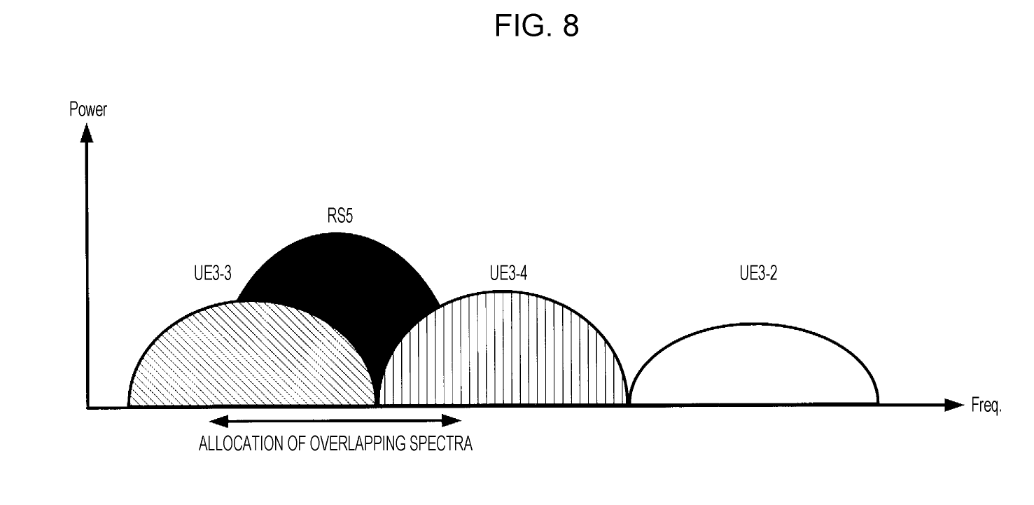

FIG. 8 illustrates an example of frequency allocation of the RS 5 according to the first embodiment of the present invention. In this embodiment, frequency division multiple access is not performed at the RS 5 and each UE 3, and the RS 5 and the UE 3 shares and uses the same frequency for transmission. Therefore, with regard to each of the UE 3-2 the UE 3-3, and the UE 3-4 that are not subject to relaying, orthogonality is maintained in a frequency domain as frequency division multiple access, whereas allocation in which the frequency-domain signal (spectrum) of the RS 5 overlaps those of UEs 3 is performed. In a case where the transmission signals of the UEs 3 and the RS 5 are multiplexed in this manner, signal separation is performed at the eNB 1 shown as an example in FIG. 6. In FIG. 6, if a signal is to be input to a soft canceller section 509-i, nothing is performed on the signal at an i-th replica extracting section 521-i since it is used for removing intersymbol interference. On the other hand, an input to a soft canceller section 509-j (i≠j) is an input in which only an overlapping spectral replica in a frequency domain as in FIG. 8 is extracted. However, since there is no spectral overlapping in the transmission in FIG. 7B, all inputs from the replica extracting section 521-i to the soft canceller section 509-j (i≠j) are zero, meaning that nothing is input.

The i-th soft canceller section 509-i receives a reception signal Rᵢ, receives a replica S′ⱼ(1≦j≦n, j≠i) generated based on the decoding result of the transmission signal of another UE 3 or RS 5 and a replica S′ᵢ generated based on the decoding result obtained by the decoding section 511-i, and performs processing based on the following expression.

[Expression 1]

R′ᵢ=Rᵢ−S′ᵢ−S′ⱼ (1)

It should be noted that R′ᵢ denotes a signal input to the equalizing section 507-i, S′ᵢ is the same as a replica output from the FFT section 519-i, and S′ⱼ denotes a replica obtained by extracting only a spectral component allocated to a frequency that overlaps the reception signal Rᵢ input to the soft canceller section 509-i from an output of the FFT section 519-j.

Accordingly, an overlapping spectrum can be separated by reception processing. Although the frequency allocation of each UE 3 and the frequency allocation of the RS 5 are both continuous frequency allocation in the example shown in this embodiment, discrete frequency allocation may be used as an alternative.

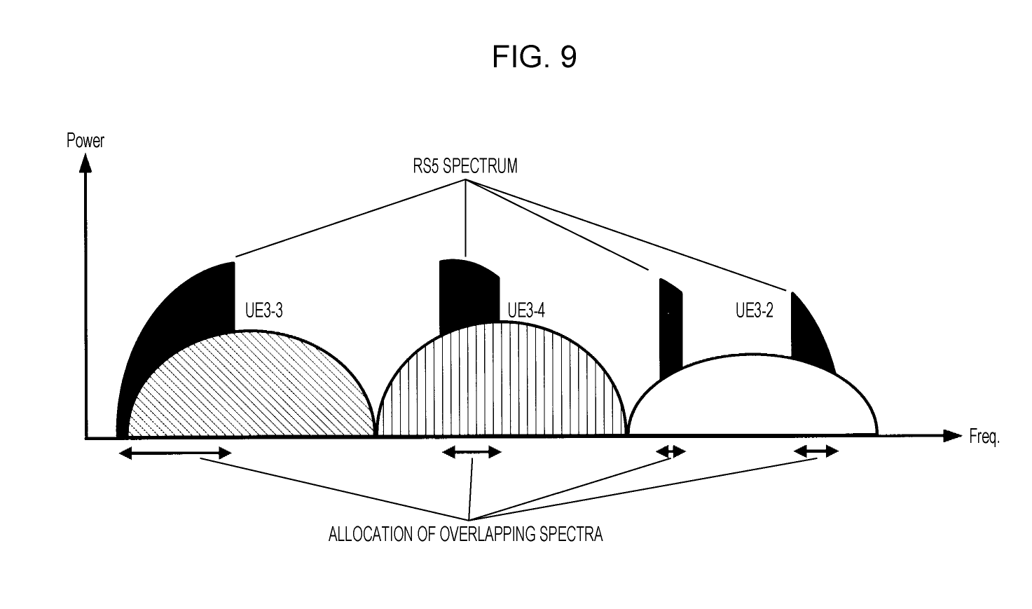

FIG. 9 illustrates an example corresponding to discrete frequency allocation of the RS 5 according to the first embodiment of the present invention. In this embodiment, the frequency allocation of the RS 5 may be performed discretely as in the drawing. With discrete allocation, the percentage of overlapping spectrum of each UE 3 is reduced.

Furthermore, although the eNB 1 in the example according to this embodiment only uses a relayed signal of a transmission signal of a UE 3 located at, for example, cell edge for reception processing, the signal transmitted from the UE 3 and the relayed signal may be combined.

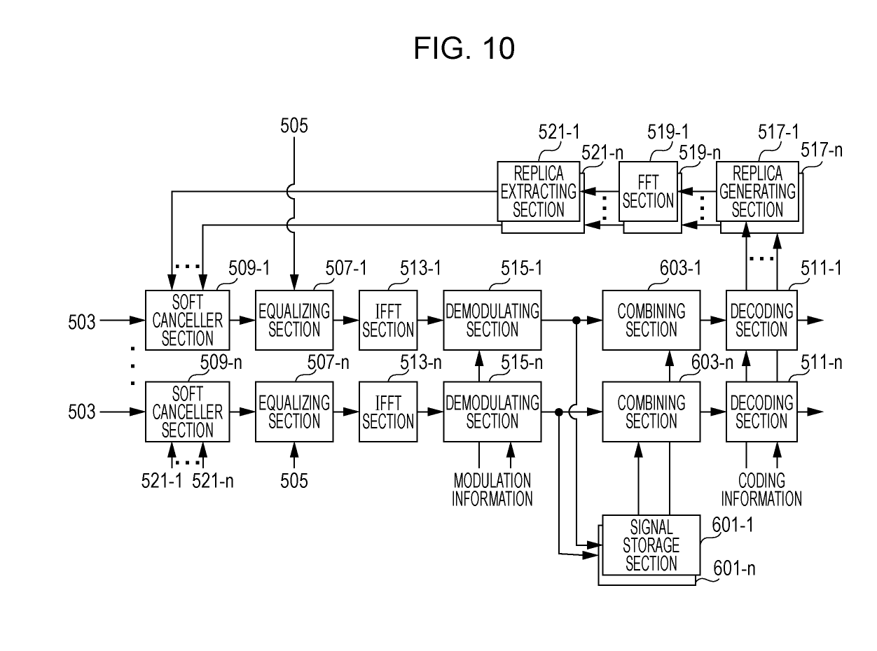

FIG. 10 is a block diagram illustrating a configuration example of a part of the eNB 1 in a case where a signal transmitted from each UE 3 and a relayed signal are to be combined, in accordance with the first embodiment of the present invention. The processing up to the demodulating sections 515-1 to 515-n (the demodulating sections 515-1 to 515-n will collectively be expressed as demodulating sections 515) is the same as that in the eNB 1 in FIG. 6. The signal of the UE 3 transmitted via the RS 5 is output from each demodulating section 515 to each of signal storage sections 601-1 to 601-n. Combining sections 603-1 to 603-n each receive a demodulated signal. In a case of performing reception processing on the relayed signal, each of the combining sections 603-1 to 603-n receives the demodulation result of the signal transmitted by the UE 3 and stored in any of the signal storage sections 601-1 to 601-n. In a case where reception processing is to be performed on the signal transmitted by the UE 3, nothing is output from the signal storage sections 601-1 to 601-n, meaning that zero is input. In each of the combining sections 603-1 to 603-n, an input from each of the demodulating sections 515-1 to 515-n and an input from each of the signal storage sections 601-1 to 601-n are added together so as to combine the signal transmitted by the UE 3 and the signal transmitted by the RS 5 with each other. The combined signal is input to each of the decoding sections 511-1 to 511-n where decoding processing is performed thereon. Subsequently, reception processing is performed in a manner similar to that in FIG. 6.

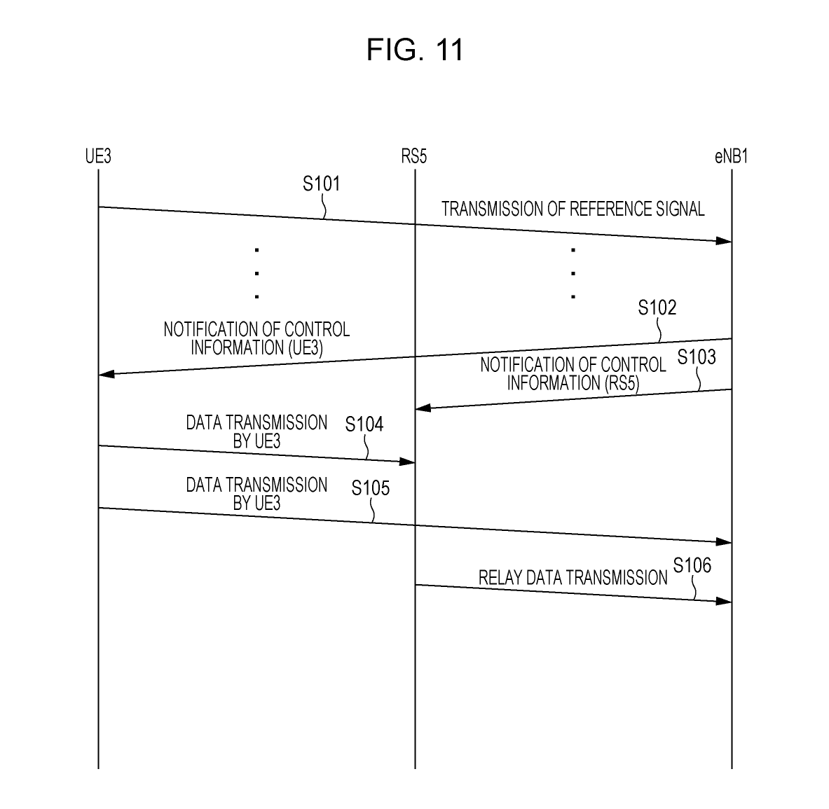

FIG. 11 is a sequence chart illustrating the operation of a communication system according to the present invention. In FIG. 11, a UE 3 transmits a reference signal alone or a signal obtained by multiplexing data and a reference signal to each other to the eNB 1 (step S101). The eNB 1 estimates a frequency response based on the received reference signal, determines, for example, frequency allocation of the UE 3 as well as a coding rate and a modulation level to be used for transmission on the basis of the estimation result, and notifies the UE 3 of the determination results as control information (step S102). Moreover, the RS 5 is similarly notified of control information including frequency allocation to be used during relay transmission and frequency allocation information to be used by the UE 3 for data transmission (step S103). In this embodiment, transmission parameters to be used for transmission, including the coding rate and the modulation level but excluding the frequency allocation, are the same as those notified to the UE 3. The timing at which the RS 5 is notified of the control information is not limited to that shown in FIG. 11. The timing may be the same as or earlier than the timing at which the UE 3 is notified of the control information so long as the timing is earlier than the relay transmission of data by the RS 5. After receiving the control information, the UE 3 performs data transmission on the basis of the transmission parameters included in the control information if there is no error in the received data based on CRC (step 5104 and step S105). However, if an error is detected, control information such as NACK (negative acknowledgement) is transmitted without performing relay transmission of data. The RS 5 and the eNB 1 each receive the data transmitted by the UE 3. When the data from the UE 3 is properly received, the RS 5 performs relay transmission to the eNB 1 (step S106). The eNB 1 performs reception processing on the signal transmitted from the RS 5 or performs reception processing on the signals transmitted from the RS 5 and the UE 3 based on a combining process as in FIG. 10, thereby obtaining the transmitted data.

Accordingly, with application of this embodiment, it becomes unnecessary to maintain the orthogonality of frequencies used for transmission by each UE 3 and the RS 5. This allows for efficient frequency use by a radio communication system including the RS 5, thereby allowing for improved frequency utilization efficiency. Furthermore, in this embodiment, since the RS 5 has extra transmission power relative to that of the UE 3 in which the transmission power is limited, the eNB 1 makes spectra with a power difference overlap each other in a frequency domain. Accordingly, overlapping and allocating the spectra of the RS 5 and the UE 3 having a power difference facilitates signal separation in reception processing, so that an effect of overlapping the spectra relative to the transmission characteristics is reduced, thus allowing for improved throughput.

### Second Embodiment

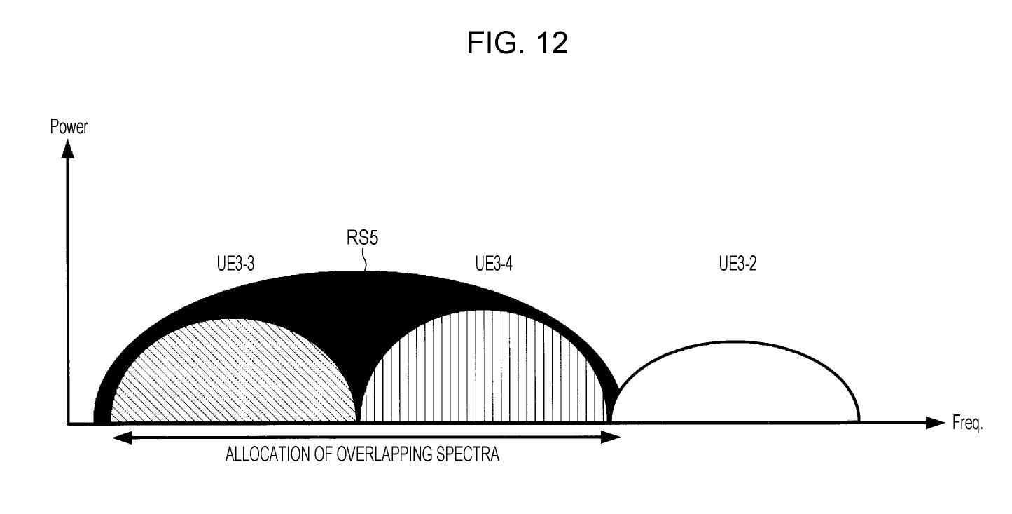

This embodiment described with reference to FIG. 12 relates to an example in which the coding rate and the modulation level to be used by the RS 5 at the time of transmission is reduced so as to improve the reliability of communication between the RS 5 and the eNB 1.

FIG. 12 illustrates an example of frequency allocation of each UE 3 and the RS 5 according to the second embodiment of the present invention. In FIG. 12, frequency allocation based on the frequency division multiple access in FIG. 7A is performed at a transmission timing where there is no transmission by the RS 5. At a subsequent transmission timing, frequency allocation in a case where a UE 3-1 signal having low reception power at the eNB 1 is relayed by the RS 5 is performed. Each UE 3 and the eNB 1 in this embodiment are the same as those in the above embodiment. The configuration example of the RS 5 is the same as that in FIG. 3 in the above embodiment but differs therefrom in terms of the transmission-signal generating process in the transmitting section 205. The transmitting section 205 inputs data bits obtained from a signal received from the UE 3-1 to the coding section 103. The coding section 103 performs coding on the data bits on the basis of coding-related information included in control information notified from the eNB 1. In this embodiment, a coding rate r_{RS} for coding to be performed at the RS 5 is set so as to satisfy the following expression.

r_{RS}=r_{UE} (2)

In this case, r_{UE} denotes a coding rate for coding to be performed at the UE 3.

Furthermore, if error correction coding used by the UE 3-1 is a turbo code, not only the coding rate may be changed, but also the code may be changed to, for example, a convolutional code in a coding method that facilitates separation of overlapping spectra. The code to be changed is not limited to a convolutional code and may alternatively be an LDPC code so long as the code is designed to facilitate separation of overlapping spectra.

In the modulating section 105 that receives coded bits, a modulation level M_{RS} to be used for modulation at the RS 5 is set so as to satisfy the following expression.

M_{RS}≦M_{UE} (3)

In this case, M_{UE} denotes a modulation level to be used for modulation at the UE 3.

In the RS 5 according to this embodiment, the coding section 103 and the modulating section 105 do not need to simultaneously satisfy Expression (2) and Expression (3) with regard to the communication parameters, and only one of the two may be applied. As another alternative, the coding method alone may be changed.

A signal modulated by the FFT section 107 is converted from a time domain to a frequency domain. Because the frequency signal output from the FFT section 107 undergoes coding and modulation so as to satisfy at least one of Expression (2) or Expression (3), a wider bandwidth is required at the time of transmission. The frequency mapping section 109 performs allocation that overlaps a transmission frequency of a UE 3 that does not go through the RS 5. As a result, signals overlapping each other in a frequency domain as in FIG. 12 are simultaneously received by the eNB 1, so that signal separation based on reception processing similar to that in the above embodiment is performed.

This embodiment relates to an example in which, when at least one of the coding rate and the modulation level is to be changed, the coding rate or the modulation level is changed on the basis of control information notified from the eNB 1. Alternatively, any of the parameters to be changed may be set in advance such that the notification based on the control information may be eliminated. Furthermore, instead of reducing the coding rate, since systematic bits serving as input bits and parity bits having undergone error correction coding are obtained in a case where turbo coding is performed by the coding section 103, the parity bits alone may be relayed and transmitted by the RS 5.

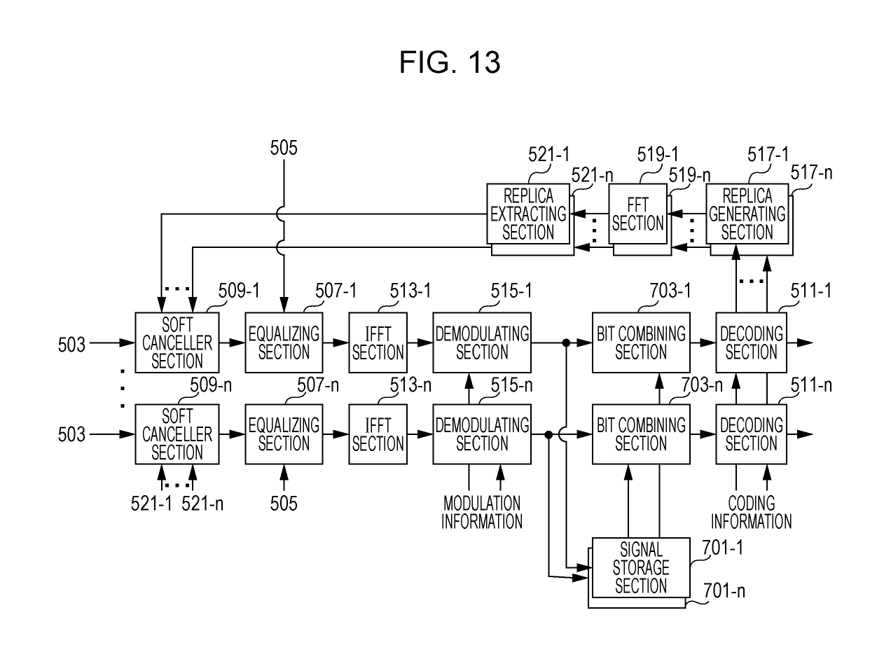

FIG. 13 is a block diagram illustrating a configuration example of a part of the eNB 1 according to the second embodiment of the present invention. In above-described case, each UE 3 transmits decimated parity bits in accordance with the systematic bits and the coding rate, whereas the RS 5 transmits parity bits alone. The processing up to the demodulating sections 515-1 to 515-n is the same as that performed by the eNB 1 in FIGS. 6 and 10, and signals including systematic bits and parity bits of the UEs 3 that perform transmission via the RS 5 are output from these demodulating sections 515 via the RS 5 to signal storage sections 701-1 to 701-n. Bit combining sections 703-1 to 703-n receive demodulated signals. In a case of performing reception processing of a relayed signal, each of the bit combining sections 703-1 to 703-n receives a demodulation result of a signal including systematic bits and parity bits transmitted from each UE 3 and stored in any of the signal storage sections 701-1 to 701-n. In a case where reception processing of the signals transmitted by the UEs 3 is to be performed, nothing is output from the signal storage sections 701-1 to 701-n. In the bit combining sections 703-1 to 703-n, the parity bits input from the demodulating sections 515-1 to 515-n and the decimated parity bits input from the signal storage sections 701-1 to 701-n are combined. In this combining processing, the parity bits transmitted from each of the UEs 3 and the RS 5 are combined by addition processing, whereas nothing is performed on the parity bits and the systematic bits transmitted from the RS 5 alone. Each of the bit combining sections 703-1 to 703-n inputs the combined signal as a signal from which parity bits are not decimated to each of the decoding sections 511-1 to 511-n where decoding processing is performed. Subsequently, reception processing is performed in a manner similar to that in FIG. 6.

A sequence chart illustrating the operation of a communication system according to this embodiment is similar to that in FIG. 11 according to the above embodiment. However, the control information to be notified to the RS 5 is different from that in the above embodiment. The information about the coding rate and the modulation level included in this control information is different from the information notified to each UE 3. For example, control information satisfying Expression (2) and Expression (3) is notified to the RS 5.

Accordingly, with application of this embodiment, it becomes unnecessary to maintain the orthogonality of frequencies used for transmission by each UE 3 and the RS 5. This allows for efficient frequency use by a radio communication system including the RS 5, thereby allowing for improved frequency utilization efficiency. Furthermore, in this embodiment, the RS 5 changes at least one of the coding rate, the modulation level, and the coding method, thereby facilitating separation of signals allocated by overlapping the spectra of the RS 5 and each UE 3. Thus, an effect of overlapping the spectra relative to the transmission characteristics is reduced, thus allowing for improved throughput. Moreover, by performing the allocation by overlapping the spectra of the RS 5 and each UE 3 having a power difference, signal separation in reception processing is facilitated, so that an effect of overlapping the spectra relative to the transmission characteristics is reduced, thus allowing for improved throughput.

### Third Embodiment

This embodiment relates to an example in which frequency allocation is performed such that the frequency to be used for transmission by the RS 5 is the same as the relay and transmission frequency to be used for transmission by each UE 3.

The configurations of each UE 3, the RS 5, and the eNB 1 in this embodiment are the same as those in the above embodiments, but the control-information receiving section 401 within the transmitting section 205 of the RS 5 is different therefrom. In the above embodiments, the control information including the frequency-allocation information of the RS 5 from the eNB 1 is received by the control-information receiving section 401 and is input to the frequency mapping section 109. In this embodiment, the control-information receiving section 401 receives control information including frequency-allocation information notified to each UE 3 that is subject to relaying of data transmission and inputs the control information to the frequency mapping section 109. In other words, the frequency position and the bandwidth to be used for transmission by the UE 3 are exactly the same as the frequency position and the bandwidth to be used for transmission by the RS 5.

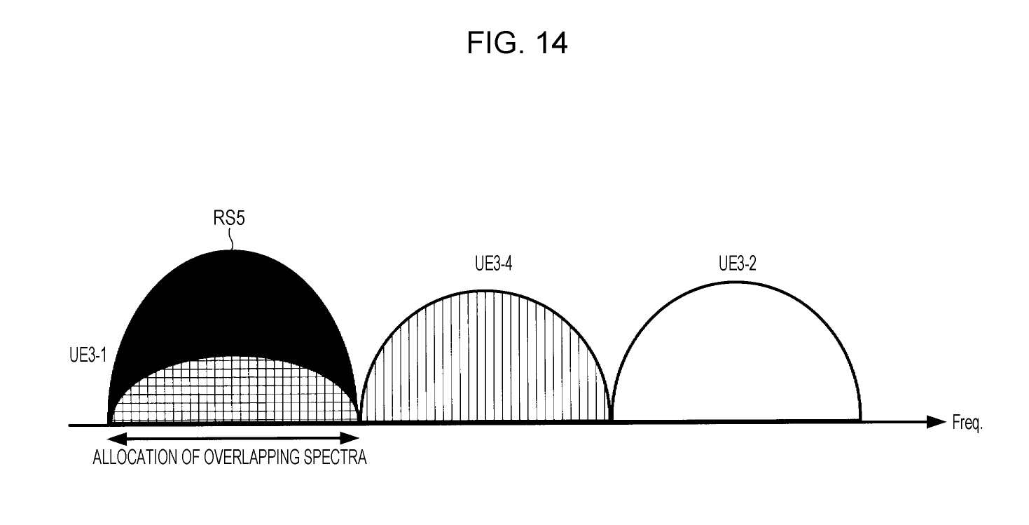

FIG. 14 illustrates an example of frequency allocation of each UE 3 and the RS 5 according to the third embodiment of the present invention. In this embodiment, frequency division multiple access, which is frequency allocation, in FIG. 7A is performed at a transmission timing where there is no transmission by the RS 5. At a subsequent transmission timing, a UE 3-1 signal having low reception power at the eNB 1 is relayed by the RS 5. In the example in FIG. 14, because the frequency allocation of the UE 3-1 and the frequency allocation of the UE 3-1 subject to relay transmission by the RS 5 are the same for both the transmission timing of the UE 3 and the transmission timing of the RS 5, the frequencies used for transmission by the UE 3-1 and the RS 5 are the same.

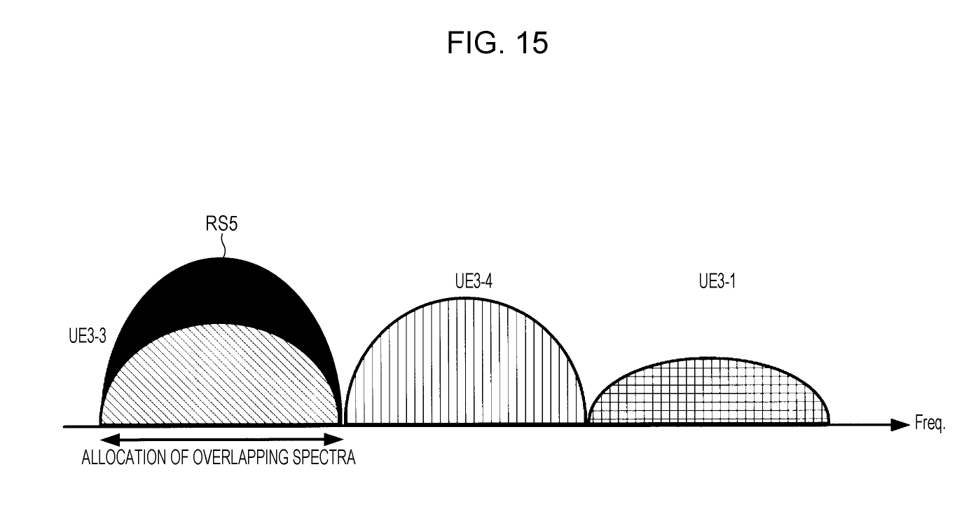

FIG. 15 illustrates another example of frequency allocation of each UE 3 and the RS 5 according to the third embodiment of the present invention. If the frequency allocation differs among all of or one or more of the UEs 3 at the transmission timing of each UE 3 and the transmission timing of the RS 5, frequency allocation as in FIG. 15 is applied.

A sequence chart illustrating the operation of a communication system according to this embodiment is similar to that in FIG. 11 according to the above embodiment. However, the control information notified to the RS 5 is different from that in the first embodiment. Frequency-allocation information, which is to be used for transmission by the RS 5, included in this control information is the same as the information notified to each UE 3.

Accordingly, with application of this embodiment, it becomes unnecessary to maintain the orthogonality of frequencies used for transmission by each UE 3 and the RS 5. This allows for efficient frequency use by a radio communication system including the RS 5, thereby allowing for improved frequency utilization efficiency. Furthermore, in this embodiment, since the frequency position and the bandwidth to be used for transmission by the RS 5 do not need to be changed, simple relaying processing can be realized. Moreover, overlapping and allocating the spectra of the RS 5 and each UE 3 having a power difference facilitates signal separation in reception processing, so that an effect of overlapping the spectra relative to the transmission characteristics is reduced, thus allowing for improved throughput.

A program executed at each UE 3 and the eNB 1 in accordance with the present invention is a program that controls, for example, a CPU (i.e., a program that makes a computer exhibit its function) so that the functions of each of the above embodiments according to the present invention are realized. Information handled in these devices is temporarily accumulated in a RAM at the time of processing thereof, and is subsequently stored in various kinds of ROMs and HDDs. Where necessary, the CPU reads out the information and performs correction and writing on the information. A storage medium that stores the program may be, for example, a semiconductor medium (e.g., a ROM, a nonvolatile memory card, etc.), an optical storage medium (e.g., a DVD, an MO, an MD, a CD, a BD, etc.), or a magnetic storage medium (e.g., magnetic tape, a flexible disk, etc.).

Furthermore, by executing the loaded program, not only the functions of each of the above-described embodiments are realized, but also processing is performed together with, for example, an operating system or another application program on the basis of the instruction of the program, so that the functions of the present invention may be achieved. When distributing the program to the market, the program may be distributed by being stored in a transportable storage medium or may be transferred to a server computer connected via a network, such as the Internet. In this case, a storage device of the server computer is also included in the present invention.

Furthermore, one or more of or all of the UEs 3 and the eNB 1 in each of the above-described embodiments may be exemplarily realized as an LSI, which is an integrated circuit. The functional blocks of the UEs 3 and the eNB 1 may be formed into individual chips, or one or more of or all of them may be integrated into a chip. The integrated circuit is not limited to an LSI and may be realized by a dedicated circuit or a general-purpose processor. Furthermore, if a technology for forming an integrated circuit that replaces an LSI emerges with the development of semiconductor technology, an integrated circuit based on that technology may be used.

Although the embodiments according to this invention have been described above with reference to the drawings, specific configurations are not limited to these embodiments. For example, a design that does not deviate from the spirit of this invention is included in the scope of the claims.

### REFERENCE SIGNS LIST

1 eNB
3-1, 3-2, 3-3, 3-4, 3 UE
5 RS
101 control-information receiving section
103 coding section
105 modulating section
107 FFT section
109 frequency mapping section
111 IFFT section
113 reference-signal multiplexing section
115 transmission processing section
117 transmission antenna
201 antenna
203 receiving section
205 transmitting section
207 amplifying section
209 transmission antenna
301 reception processing section
303 reference-signal separating section
305 channel estimating section
307 FFT section
309 equalizing section
311 frequency demapping section
313 soft canceller section
315 decoding section
317 FFT section
319 replica generating section
321 FFT section
401 control-information receiving section
501 antenna
503 frequency demapping section
505 channel estimating section
507-1 to 507-n equalizing sections
509-1 to 509-n soft canceller sections
511-1 to 511-n decoding sections
513-1 to 513-n IFFT sections
515-1 to 515-n demodulating sections
517-1 to 517-n replica generating sections
519-1 to 519-n FFT sections
521-1 to 521-n replica extracting sections
601-1 to 601-n signal storage sections
603-1 to 603-n combining sections
701-1 to 701-n signal storage sections
703-1 to 703-n bit combining sections

1-10. (canceled)

11. A radio relay method for relaying a radio signal exchanged between a mobile station and a base station, the radio relay method comprising:
relaying at least one of transmission signals generated from transmission data of a plurality of the mobile stations such that the relayed transmission signal generated from the transmission data is relayed based on allocation of a frequency that is different from and that at least partially overlaps allocation of a frequency of another non-relayed transmission signal generated from the transmission data.

12. The radio relay method according to claim 11, wherein the frequency to be used for transmitting the relayed transmission signal is disposed discretely on a frequency axis.

13. The radio relay method according to claim 11, wherein reception power of the relayed transmission signal at the base station is higher than reception power of said another non-relayed transmission signal at the base station.

14. The radio relay method according to claim 11, wherein, at a frequency at which the relayed transmission signal and said another non-relayed transmission signal are multiplexed, the number of multiplexed transmission signals is larger than the number of reception antennas included in the base station.

15. The radio relay method according to claim 11, wherein at least one of a modulation level and an encoding ratio of the relayed transmission signal is lower than a modulation level or an encoding ratio of said another non-relayed transmission signal.

16. The radio relay method according to claim 11, wherein error correction encoding relative to the relayed transmission signal is different from error correction encoding relative to said another non-relayed transmission signal.

17. A base station that receives a radio signal from a mobile station and a relay station,
wherein in a case where the relay station relays at least one of transmission signals generated from transmission data of a plurality of the mobile stations, replicas are generated based on the transmission signal transmitted from each mobile station and the transmission signal generated from the data relayed based on allocation of a frequency that is different from and that at least partially overlaps allocation of a frequency of another non-relayed transmission signal generated from the transmission data, and wherein the generated replicas are used for interference removal so as to perform reception processing on the transmission signal transmitted from the relay station and the transmission signal transmitted from each mobile station.

18. The base station according to claim 17, wherein the relay station is notified that at least one of a modulation level and an encoding ratio of the relayed transmission signal is lower than a modulation level or an encoding ratio of said another non-relayed transmission signal.

19. The base station according to claim 17, wherein reception processing for combining the transmission signal transmitted from each mobile station with the transmission signal relayed by the relay station is performed.

20. A radio communication system comprising a mobile station, a base station, and a relay station, the relay station relaying a radio signal exchanged between the mobile station and the base station,
wherein the relay station relays at least one of transmission signals generated from transmission data of a plurality of the mobile stations based on allocation of a frequency that is different from and that at least partially overlaps allocation of a frequency of another non-relayed transmission signal generated from the transmission data.
